(19) United States
(12) Patent Application Publication
(10) Pub. No.: US 2013/0219257 A1
(43) Pub. Date: Aug. 22, 2013

(54) TEXTUAL AND FORMATTED DATA PRESENTATION

(71) Applicants: Boaz Carmeli, Koranit (IL); Carmel Kent, Zippori (IL); Yonatan Maman, Hof Hacarmel (IL); Ruty Rinott, Jerusalem (IL); Yoav Rubin, Haifa (IL); Noam Slonim, Jerusalem (IL)

(72) Inventors: Boaz Carmeli, Koranit (IL); Carmel Kent, Zippori (IL); Yonatan Maman, Hof Hacarmel (IL); Ruty Rinott, Jerusalem (IL); Yoav Rubin, Haifa (IL); Noam Slonim, Jerusalem (IL)

(73) Assignee: International Business Machines Corporation, Armonk, NY (US)

(21) Appl. No.: 13/400,074

(22) Filed: Feb. 19, 2012

(51) Int. Cl. G06F 17/00

(52) U.S. Cl. 715/226

(57) ABSTRACT

A computer-implemented method and apparatus, the apparatus comprising an information receiving component, a text presentation component for presenting at least a first part of the information on a first pane as text; a form presentation component for presenting at least a second part of the information as a structured form comprising one or more fields on a second pane; and an update component for updating information displayed in the first pane or the second pane in response to changes entered to information displayed in the second pane or in the first pane, respectively.

### TECHNICAL FIELD

The present disclosure relates to user interfaces in general, and to a method and apparatus for presenting data in particular.

### BACKGROUND

Computerized devices and systems control almost every aspect of our life both as individuals and as a society. Many of the computerized systems gather or use significant amounts of data about products, processes, individuals, and other entities.

User interface (UI) is an important part of using computerized system.

The term UI generally refers to the space where interaction between humans and machines occurs, the goal of which is effective operation and control of the machine, and feedback from the machine which aids the operator in making operational decisions. UI may refer to input and/or output, i.e., displaying information to a user and receiving information from a user.

UI can take many forms, such as visual, auditory, or others. The visual UI is highly useful and is a part of almost any computerized system.

The visual UI usually comprises displaying information on a graphic display, presenting for example text, structured forms, images, or the like, and receiving information from a user using any device, such as text, selections, importation of data or others performed using a keyboard, a pointing device such as a mouse, a touch screen, or the like.

It is a general goal of UI designers to make the user interface easy, efficient, and enjoyable to operate a system in a way which produces the desired result. This generally means that the operator needs to provide minimal input to achieve the desired output, and that the output is designed to reflect information to the user in an efficient manner.

### BRIEF SUMMARY

One exemplary embodiment of the disclosed subject matter is a computer-implemented method performed by a computerized device, comprising: receiving information; and displaying simultaneously the information as text on a first pane, and as a structured form comprising at least one field on a second pane, wherein at least part of the text or the at least one field is derived from the at least one field or the at least part of the text, respectively.

Yet another exemplary embodiment of the disclosed subject matter is an apparatus having a processing unit and a storage device, the apparatus comprising: an information receiving component; a text presentation component for presenting at least a first part of the information on a first pane as text; a form presentation component for presenting at least a second part of the information as a structured form comprising at least one field on a second pane; and an update component for updating information displayed in the first pane or the second pane in response to changes entered to information displayed in the second pane or in the first pane, respectively.

Yet another exemplary embodiment of the disclosed subject matter is a computer program product comprising: a non-transitory computer readable medium; a first program instruction for receiving information; and a second program instruction for displaying simultaneously at least a first part the information as text on a first pane, and at least a second part of the information as a structured form comprising at least one field on a second pane; wherein at least part of the text or the at least one field is derived from the at least one field or the at least part of the text, respectively, and wherein said first and second program instructions are stored on said non-transitory computer readable medium.

Yet another exemplary embodiment of the disclosed subject matter is a computer program product comprising: a non-transitory computer readable medium; a first program instruction for receiving information; and a second program instruction for displaying simultaneously at least a first part the information as text on a first pane, and at least a second part of the information as a structured form comprising at least one field on a second pane, wherein information displayed on the first pane or the second pane is changed in response to changes entered to information displayed on the second pane or the first pane, respectively, and wherein said first and second program instructions are stored on said non-transitory computer readable medium.

Another exemplary embodiment of the disclosed subject matter is a computer-implemented method performed by a computerized device, comprising: receiving information; and displaying simultaneously at least a first part the information as text on a first pane, and at least a second part of the information as a structured form comprising at least one field on a second pane, wherein information displayed on the first pane or the second pane is changed in response to changes entered to information displayed on the second pane or the first pane, respectively.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a user interface in accordance with the disclosure, before information is entered;

FIG. 1B shows the user interface of FIG. 1A, with entered text has been entered;

FIG. 1C shows the user interface of FIG. 1A, with entered text and extracted fields, in accordance with the disclosed subject matter;

FIG. 2 shows a flowchart of steps in a method for providing dual user interface, in accordance with some exemplary embodiments of the disclosed subject matter; and

FIG. 3 shows a block diagram of components of an apparatus for dual user interface, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is the discrepancy between various methods which may be used in user interface systems. For example, some users feel more comfortable to use a system displaying and receiving free text describing a situation, while others may prefer using structured forms. The preferences may change between users, between the same user according to whether he or she is entering data or receiving data, according to different applications used, or the like.

The situation may become even more complex when the same data is used, i.e., entered or consumed by different people and systems. Thus, one person may prefer to describe a situation using free text, while another person or a computerized system that has to access or process the data, may require the data in a structured form.

Entering the data in two formats, for example by entering free text and by filling a form, is inefficient, requires redundant work and may also result in errors caused by inconsistencies in entering the data.

Another technical problem dealt with by the disclosed subject matter relates to transforming information already existing in one format into another format. For example, an archive such as a medical archive, may comprise multitude of hand-written documents. In order to use the documents for purposes such as research, the documents may be scanned, and their contents may be transformed into text using tools such as Object Character Recognition (OCR). The extracted text may contain errors due to imperfect operation of the OCR or incomprehensible handwriting. In addition, the free text as extracted may also be inconvenient for computerized purposes, and it may be further required to automatically extract the data, which may again result in deficiencies, inconsistencies or other errors.

One technical solution comprises a method, apparatus and product for a dual UI, which presents simultaneously free text on one pane, and a structured form on another pane, wherein field values in the structured form are derived from the free text, or vice versa. A user using the UI may change the free text, which may cause immediate change in one or more of the fields of the structured form. Additionally, the user may change any of the fields of the form, which may change immediate change some or all of the displayed text.

The fields may be derived from the text using any method such as Free-text Natural Language Processing (NLP). Text can be generated from the structured form using predetermined templates. For example, a medical for with an age field having a value of 35, may be translated to “the patient is 35 years old”.

In some exemplary embodiments, the derivation of the fields or the text from one another may be application- or domain-specific. For example, in medical applications, the text is likely to contain gender and age fields, so that a system converting from text to structured form may search for information that may be relevant to these fields, while on other domains these may not be relevant, and the notion of years may be related to a different detail.

In some exemplary embodiments, the structured form may comprise indications to mandatory fields, such as age or gender. If these fields cannot be derived from the form, the user may be required to complete them. The information may then be added to the text pane as well.

In some exemplary embodiments, if a field cannot be clearly determined from the text, the assumed value may be presented, with an indication to the user to check and/or change them.

An indication may be associated with each field for indicating whether the text reflects the current value of the field. For example, if a form was updated externally to the user interface, it will be indicated that the text does not reflect the value, so the next time the UI is presented, corresponding text may be generated.

In some exemplary embodiments, a field may be checked for validity. For example, a patient age field in a form associated with pediatrics may be limited to larger than 0 and smaller than 18. If the extracted value is outside these limits, an indication may be provided, or the field may be left empty.

In some exemplary embodiments, the system can retrieve free text from any source, for example pre-existing text files which may have been entered by a user, scanned and retrieved using OCR from paper documents, or the like. In such embodiments, the pre-existing text is analyzed when received, and fields of the form are completed. The user can then check the structured form for errors, and correct them. If information is missing, the user can complete it.

If the original text was handwritten, it may be displayed as well. If the original text is displayed as well, the user can then update the text or the structured form, which may then cause update of the other.

One technical effect of the disclosed subject matter is the provisioning of user interface with which a user can enter data in a convenient way, be it text or filling a form, such that the data is immediately available and simultaneously displayed in the other format as well. The information as received from a user or from another source is transformed to the other format so the user can check and compare the information as presented in the two forms. For research or statistical purposes, it is generally easier to use a structured form, while for some human users, it may be easier to introduce the data in free text form. The user interface provides the coordinated dual presentation, so that advantages of both disciplines may be enjoyed.

Another technical effect of the disclosed subject matter relates to partial batch processing of pre existing documents. The disclosed solution enables the possibly offline extraction of structured information from free text, followed by displaying the original and extracted information to a user who can then check the data extraction for errors in missing items.

Yet another technical effect of the disclosed subject matter relates to enabling a user to keep a snippet of personal information in free text form. Whenever the user is required to fill a form, he can copy and paste the information snippet into the text pane, such that at least some of the fields in the form are extracted automatically.

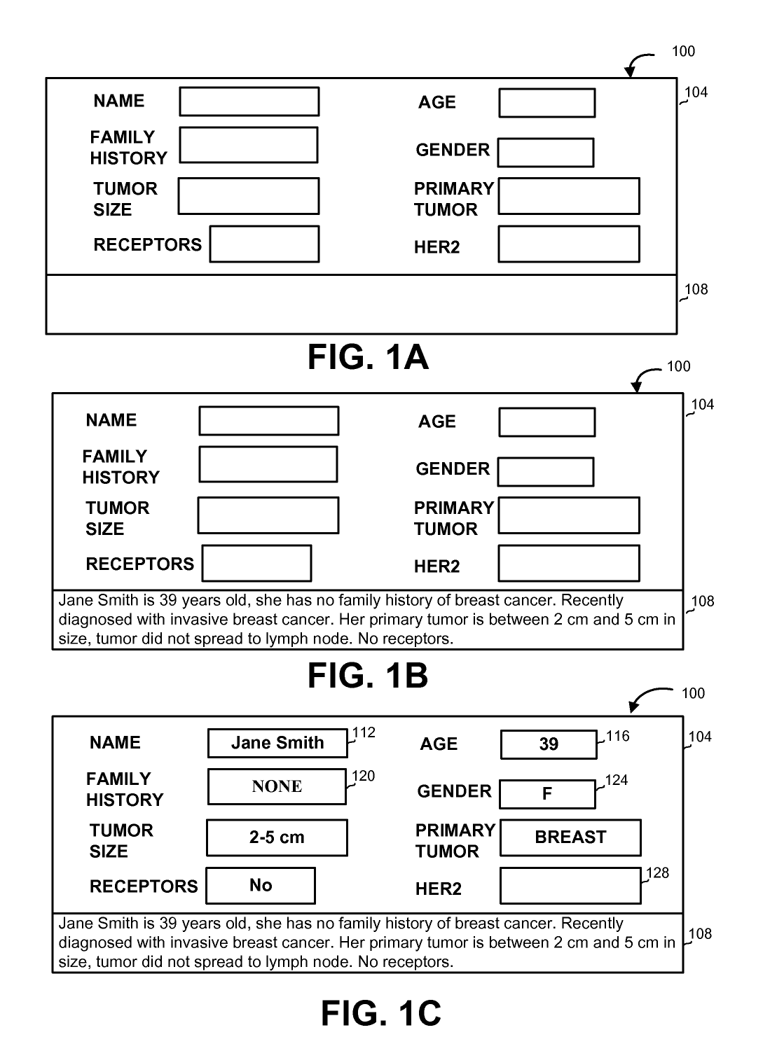

Referring now to FIGS. 1A-1C, showing an exemplary dual user interface and its usage, in accordance with the disclosed method and apparatus.

FIG. 1A shows a user interface 100 adapted to be displayed on a display device associated with a computing platform. User interface 100 comprises a structured form pane 104 and text pane 108. The exemplary user interface 100 is related to Oncology and therefore comprises demographic details as well as tumor-related details. In the situation displayed in FIG. 1A, no information has been loaded or entered into the form. It will be noted that the disclosed subject matter is not limited to oncology or medicine and the disclosed subject matter may be applied to any field, such as insurance, accident reporting, or the like.

FIG. 1B shows user interface 100 after a user entered imported text, pasted it from a digital clipboard, or brought it in any other manner, and the text is displayed in pane 108.

FIG. 1C shows user interface 100 with the text as shown in FIG. 1B on pane 108, as well as values corresponding to fields of the computerized form displayed in pane 104, as derived from the text. Thus, the patient's name is derived and displayed in field 112 although the word “Name” does not appear in the text, the patient's age is derived, possible through the words “years old” and displayed in field 116. Additional fields are derived as shown, including for example the family history filed 120 and gender field displayed in field 124, which may be derived using the word “she” appearing in the text, and details relating to the medical situation. Details that cannot be extracted from the text, such as the “HER2” filed 128 are left empty. For such fields, an indication may be provided that the field is mandatory, or a default value may be suggested.

The user can complete the missing information by typing additional text in pane 108 from which the value will be derived and presented in field 128, or by filling the required field such as field 128 from which text may be generated and added to the text on pane 108.

It will be appreciated that some fields, such as the name field may be free-text fields, while others such as the gender field may require a user to select a value from a predetermined list, or may otherwise have a domain of possible values. In case the text in pane 108 provides information that does not comply with the relevant domain, an invalidity notification may be provided to the user. For example an indication may be provided if the text contains reference to a patient older than 18, wherein the form relates to pediatrics.

In some exemplary embodiments, deriving data from pane 108 and displaying the derived data in pane 104 may be in response to a user input, such as pushing a “Compute” button (not shown). Additionally or alternatively, in response to an edit event on the text field of pane 108, the data may be derived and displayed.

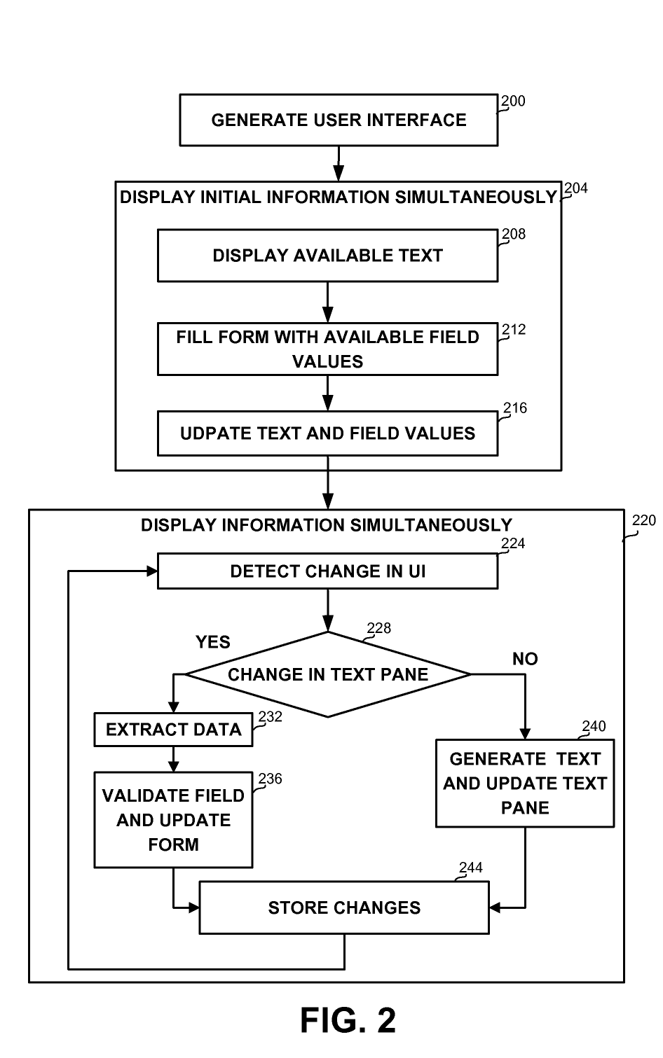

Referring now to FIG. 2, showing a flowchart of steps in a method for providing dual user interface.

On step 200 a user interface is displayed for example as a form, a window, a dialog, or the like, which comprises a structured form part, such as a first pane, and a free text part, such as a second pane. The user interface may be generated using a fixed template, a template constructed ad-hoc, or the like.

On optional initial information display step 204, initial information may be displayed on the user interface, wherein the information may be loaded from a storage device associated with the computing platform. For example, in repeated visits of a patient in a clinic, information from previous visits may be loaded.

Initial information display step 204 may comprise step 208 of displaying available text in the text pane, and step 212 of displaying available field values. The field values may be available through earlier extraction, inserted through another mechanism such as database updated, or the like.

Initial information display step 204 may comprise update text and field values step 216 in which the information is transferred between the text pane and the structured form pane, such that newly added text is searched for additional fields to be completed, text is generated upon newly updated field values and the new text is added to the text pane.

On ongoing simultaneous information display step 220, information is displayed simultaneously in the text pane and in the structured form pane.

On substep 224, changes may be detected in the user interface.

Then it may be determined on step 228, which may be performed as part of substep 224, whether the change is in the text pane or in the structured form pane.

If the change is in the text pane, then on step 232 data relevant to values of one or more fields may be extracted from the text and updated in the structured form pane.

In some embodiments, the whole text may be re-analyzed and text may be extracted, while in other embodiments only the newly added text may be analyzed.

In some embodiments, the text may be analyzed and data may be extracted as the user is typing or otherwise inserting the text, while in other embodiments the text may be analyzed only when the user clicks a “Submit” icon, interacts with a GUI element, or otherwise indicates the text is complete.

The data may be extracted using tools such as free text natural language processing, as described for example in “Using natural language processing to analyze physician modifications to data entry templates” by Wilcox et al., published in Proc AMIA Symp. 2002, pp. 899-903, or in “Clinical Language Understanding” found at www.nuance.com/for-healthcare/understand-everything/clinical-language-understanding/index.htm, both references incorporated herein by reference.

On validation and update substep 236 the extracted data may be validated. For example, bounds may be validated for age, blood pressure, or any other field, a name cannot contain non-letter characters, or the like. In some exemplary embodiments, validation of a data may be with respect to a predetermined domain associated with the field, such as possible eye colors (e.g., green but not blonde), grades (e.g., A, B, C, D and F but not E or X), or the like. The data may then be used for updating the computerized form.

If on substep 228 it is found that the change was in the computerized form part, then on generate new text and update text pane step 240 relevant text may be generated and the text pane may be updated. If the change in the structured form is in a field which had a previous value, then the displayed text may be updated to reflect the value change. If, however, the change comprises assigning a value to a previously empty field, new text may be generated and added to the text displayed in the text pane.

On optional step 244, the current text as displayed in the text pane and the values of the structured form may be stored in a storage device, for example in a form of database, files or the like. Storing can be performed in an ongoing manner or once the user clicked a “Save” icon or otherwise indicated that he would like to save the current data.

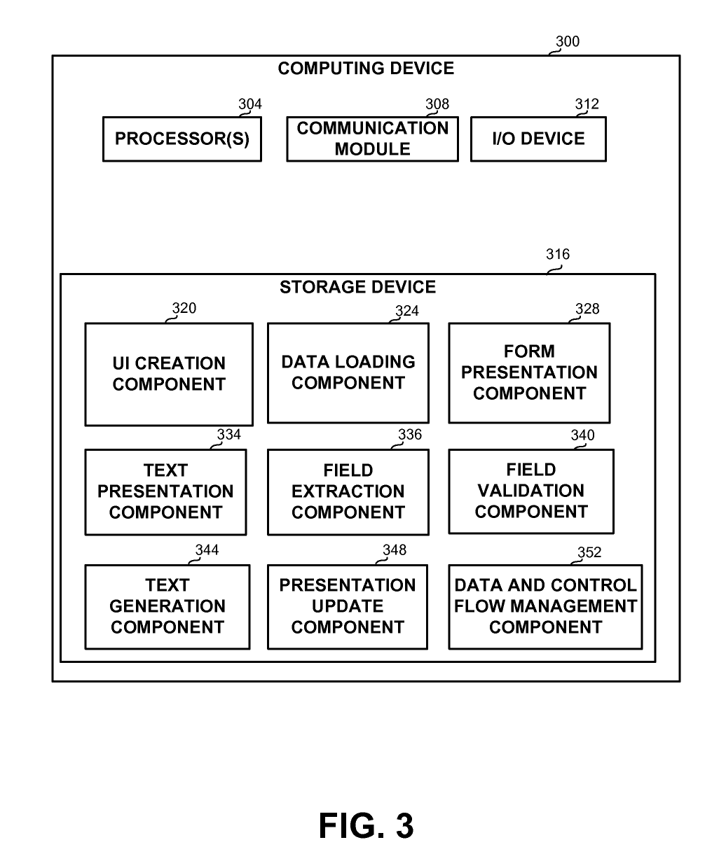

Referring now to FIG. 3 showing a block diagram of components in an apparatus for providing dual user interface.

The apparatus comprises a computing device 300, which may comprise one or more processors 304. Any of processors 304 may be a Central Processing Unit (CPU), a microprocessor, an electronic circuit, an Integrated Circuit (IC) or the like. Alternatively, computing device 300 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processors 304 may be utilized to perform computations required by computing device 300 or any of it subcomponents.

In some exemplary embodiments of the disclosed subject matter, computing device 300 may comprise communication module 308. Communication module 308 may be utilized to provide communication between the apparatus and external systems, such as databases, the Internet, other computing platforms or the like.

In some embodiments, computing device 300 may comprise an input-output (I/O) device 312 such as a terminal, a display, a keyboard, an input device or the like to interact with the system, to invoke the system and to receive results.

Computing device 300 may comprise one or more storage devices 316 for storing executable components, and which may also contain data during execution of one or more components. Storage device 316 may be persistent or volatile. For example, storage device 316 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 316 may retain program code operative to cause any of processors 304 to perform acts associated with any of the steps shown in FIG. 2 above, for example intercepting commands, formulating problems, creating further commands, or others.

The components detailed below may be implemented as one or more sets of interrelated computer instructions, executed for example by any of processors 304 or by another processor. The components may be arranged as one or more executable files, dynamic libraries, static libraries, methods, functions, services, or the like, programmed in any programming language and under any computing environment.

Storage device 316 may comprise one or more executable components such as modules, libraries or the like, which can be executed on computing platform 300 by any one or more of processors 304. Alternatively, any of the executable components may be executed on any other computing device which may be in direct or indirect communication with computing platform 300.

Storage device 316 may comprise UI creation component 320 for creating the dual user interface, which comprises a structured form pane and a free text pane as described in association with FIG. 1 above. The UI may be created using a template, calculated on the fly, retrieved from a configuration file, or the like.

Storage device 316 may comprise data loading component 324 for receiving text and form values to be displayed in the UI created by UI creation component 320. The data may be loaded from any file, database or any other source, stored on storage device 316 or any other storage device.

Additional component of storage device 316 may be form presentation component 328 and text presentation component 334, for displaying the relevant values in the various fields of the structured form pane, and displaying text in the text pane of the user interface, respectively.

A further component of storage device 316 may be field extraction component 336 which extracts information relevant to a specific field from the text. Field extraction component 336 may use any natural language processing device or software. Field extraction component 336 may be general purpose, domain-specific or any combination thereof. For example, standard fields such as name or age may be generic, while more specific fields may be tailored to a specific application.

Yet other component stored on storage device 316 may be field validation component 340 for validating whether a specific value comprises with predetermined limitations associated with a particular field.

Storage device 316 may comprise text generation component 344 for generating text upon a field having a value. In some cases the text may comprise the field title and the field value. In other cases, the field can have specific phrasing, and may even combine text from a number of fields. For example an age field with a value of 52, a name field having a value “Jane Smith” and a gender field having a value of female may be converted to the following text “Ms. Smith is 52 years old”. Text generation component 344 may be adapted to change the currently displayed text, if for example the field value is changed rather than entered for the first time. For example, if in FIG. 1 the user would change field 116 to indicate that Ms. Smith is 37 years old, the text in pane 108 may change into “Jane Smith is 37 years old . . . ”

Storage device 316 may comprise presentation update component 348 for updating the presentation of the panes, and in particular updating the text pane when any field value is changed, and updating one or more field values if the text changes.

Storage device 316 may also comprise data and control flow management component 352, for managing the information and control flow among the detailed components. For example, data and control flow management component 352 may be responsible and comprise corresponding components for receiving change indication in the user interface from form presentation component 328, activating field extraction component 336 or text generation component 344, and updating the display using presentation update component 348.

In some exemplary embodiments, the method and apparatus may provide for dual presentation user interface, in which free text and structured form relating to the same information may be presented and updated simultaneously.

The method and system may be used in a variety of applications, for example medical environment, insurance-related environment, accident reporting environment, or the like.

The method and system may also be used to make it easier for a user to complete everyday forms, such as hotel check-in forms. For example, the user may keep on a portable storage device a snippet of information as follows: My name John Dow, I live in 23 Main St. at Ridgefield Conn. My email address is john.dow@gmail.com. My driver license no. is 12345467, my credit card is American Express with number 123456789 and expiration February, 2013 . . . ”. When the user is required to fill a form, he can copy and paste the information to the text pane, and the system will automatically complete the available details it expects.

The user can then just paste this information into the free text section and let the application fill in the details into the form automatically.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
receiving information; and
displaying simultaneously the information as text on a first pane, and as a structured form comprising at least one field on a second pane,
wherein at least part of the text or the at least one field is derived from the at least one field or the at least part of the text, respectively.

2. The computer-implemented method of claim 1, further comprising storing the information displayed on the first pane as text and the information displayed on the second pane as structured information.

3. The computer-implemented method of claim 1, wherein information displayed in the at least one field of the structured form is determined by performing natural language processing on at least a part of the text displayed on the first pane.

4. The computer-implemented method of claim 1, wherein validity of information to be displayed in the at least one field of the structured form is verified against a predetermined rule.

5. The computer-implemented method of claim 4, further comprising displaying a message if the information to be displayed does not comply with the predetermined rule.

6. The computer-implemented method of claim 1, further comprising generating new text from information received in structured form and updating the text displayed on the first pane with the new text.

7. The computer-implemented method of claim 1 further comprising displaying an indication that at least one field in the structured form is mandatory.

8. The computer-implemented method of claim 1, wherein the text and the structured form present medical information related to a patient.

9. The computer-implemented method of claim 1, wherein the text and the structured form present insurance-related information of a customer.

10. A computer-implemented method performed by a computerized device, comprising:
receiving information; and
displaying simultaneously at least a first part the information as text on a first pane, and at least a second part of the information as a structured form comprising at least one field on a second pane,
wherein information displayed on the first pane or the second pane is changed in response to changes entered to information displayed on the second pane or the first pane, respectively.

11. An apparatus having a processing unit and a storage device, the apparatus comprising:
an information receiving component;
a text presentation component for presenting at least a first part of the information on a first pane as text;
a form presentation component for presenting at least a second part of the information as a structured form comprising at least one field on a second pane; and
an update component for updating information displayed in the first pane or the second pane in response to changes entered to information displayed in the second pane or in the first pane, respectively.

12. The apparatus of claim 11, wherein the text and information displayed in the structured form are stored on a storage device.

13. The apparatus of claim 11, further comprising a field extraction component for determining data to be displayed in the at least one field from at least a part of the text.

14. The apparatus of claim 11, further comprising a text generation component for creating text based on information received in structured form.

15. The apparatus of claim 11, further comprising a field validation component for verifying validity of information to be displayed in the at least one field of the structured form against a predetermined rule.

16. The apparatus of claim 11, wherein the text and the structured form present medical information related to a patient.

17. The apparatus of claim 11, wherein the text and the structured form present insurance-related information of a customer.

18. A computer program product comprising:
a non-transitory computer readable medium;
a first program instruction for receiving information; and
a second program instruction for displaying simultaneously at least a first part the information as text on a first pane, and at least a second part of the information as a structured form comprising at least one field on a second pane,
wherein at least part of the text or the at least one field is derived from the at least one field or the at least part of the text, respectively, and
wherein said first and second program instructions are stored on said non-transitory computer readable medium.

19. A computer program product comprising:
a non-transitory computer readable medium;
a first program instruction for receiving information; and
a second program instruction for displaying simultaneously at least a first part the information as text on a first pane, and at least a second part of the information as a structured form comprising at least one field on a second pane,
wherein information displayed on the first pane or the second pane is changed in response to changes entered to information displayed on the second pane or the first pane, respectively, and
wherein said first and second program instructions are stored on said non-transitory computer readable medium.
